(19) United States
(12) Patent Application Publication
(10) Pub. No.: US 2012/0042146 A1
(43) Pub. Date: Feb. 16, 2012

(54) DEVICE AND METHOD FOR STORAGE, RETRIEVAL, RELOCATION, INSERTION OR REMOVAL OF DATA IN STORAGE UNITS

(76) Inventor: Kamlesh GANDHI, Andra Pradesh (IN)

(21) Appl. No.: 13/282,082

(22) Filed: Oct. 26, 2011

Related U.S. Application Data
(63) Continuation of application No. PCT/IN2010/000259, filed on Apr. 26, 2010.

(30) Foreign Application Priority Data
Apr. 27, 2009 (IN) 442/CHE/2009

(51) Int. Cl. G06F 12/02

(52) U.S. Cl. 711/165; 711/E12.002

(57) ABSTRACT

A method and system for managing data in a storage unit is provided. The method includes insertion, removal and relocation of data by maintaining and using spare capacity in the storage unit. The method includes relocation of one or more data elements by remapping data in a storage unit. The method further includes insertion of one or more data elements in a storage block of a storage unit. The method also further includes removal of one or more data elements from a storage block of a storage unit. Furthermore, the method includes insertion of one or more ranges of addresses in storage blocks. The method also includes removal of one or more storage blocks from the storage unit.

This application is a continuation of and claims priority under 35 U.S.C. §120 to PCT Application No. PCT/IN2010/000259, filed Apr. 26, 2010 in India, designating the U.S., and claims priority under 35 U.S.C. §119 to Indian patent application no. 442/CHE/2009, filed Apr. 27, 2009 to which PCT/IN2010/000259 claims priority, both of which are hereby incorporated in their entireties by reference.

### TECHNICAL FIELD

The disclosed embodiments relate, in general, to data storage systems in computing devices, and more specifically, to storage and retrieval of data in storage units, including files, memory regions, and data structures, in computing devices.

### BACKGROUND

Each computing device has a data storage system. A data storage system provides one or more storage units. Typically, data is stored as a series of data elements, such as bytes, characters, integers, or records, in a storage unit.

A storage unit provides methods for storage and retrieval of data at a number of logical addresses in a logical address space. The storage unit can be, for example, a memory region in a memory system, a storage file in a file system, a data structure, and the like.

### Logical Address Space and Storage Blocks

In some data-storage systems, storage units store data in one or more sections, referred to as storage blocks, on an associated storage medium. A storage block has a range of storage addresses for storing data elements. The address of a data item in a storage block is called the physical address of the data item. In some cases, a storage block may be configured to have a number of ranges of storage addresses, and each range of storage addresses may have one or more storage addresses. Each storage address in a range of storage addresses in a storage block is associated with a logical address. When accessing data in a storage unit, the logical address of the data is converted to its physical address by identifying the associated storage block and an address within the storage block. In some cases, the physical address must be further translated to derive a usable address.

In a virtual memory system, the logical address space is also called the virtual address space. A number of pages are associated with the virtual address space. Thus each page may be considered a storage-block. In some cases, these pages may, at various times, be stored in physical memory or on disk. The system maintains a consistent association of the data in the pages with the virtual addresses, irrespective of the location of the pages at any point of time. Thus, each cluster on the disk in which virtual memory data is stored may also be considered a storage block.

In a file system, the data in a file is stored in a number of storage blocks, called sectors, clusters, etc. The file system maintains an association or mapping of a number of addresses in the sectors with a number of logical addresses in the file. In many cases, the storage block represents a physical storage-region on an associated storage medium such as a disk, or a network resource.

Some data structures provide a logical address space having a number of offsets or indexes for storing data elements. In some data structures, such as arrays, the logical address space is the same as the physical address space. In other data structures, such as linked-lists, data elements are stored in a number of nodes or the like, and the logical address space is distinct from the physical address space. Each node may thus be considered a storage block. Some data structures that store persistent data are also called file structures.

### Insertion and Removal

Many storage units provide efficient methods for storage and retrieval of data elements at their logical addresses. However, efficient methods for insertion or removal of data within the storage unit are not provided.

A number of simplistic alternative methods are sometimes used to insert or remove data in a storage unit. For example, in some of the existing data storage systems, insertion or removal of data elements within a storage unit is performed by moving data within the storage unit. The method involves performing read and write operations for a large amount of data. The entire data beyond the point of insertion or removal needs to be modified. This method is quite inefficient where the amount of data is large, and requires a significantly large amount of data processing device time for completing the process.

In another method, a storage unit is re-created after insertion or removal of data. All data from the first storage unit after insertion or removal of data is copied to a second storage unit. This method is also quite inefficient for large storage units.

In an existing data-storage system, when a single character, word or phrase is inserted into a data-processing application, such as a word-processing or text-editor application, the data processing device retrieves the entire storage unit, modifies the data and then stores the data to the storage unit. The entire data in the storage unit will be accessed by the data processing device, leading to inefficient utilization of data-processing device time.

In another text-editor application, an operation involving removal of a number of data elements from one position and insertion of the same at another position requires a large amount of time.

In an ‘insertion-sort’ method for maintaining a number of items in sorted order in a sorted array, the efficiency of the method quickly deteriorates as the number of data-elements in the sorted array increases.

The efficiency of these methods degrades as the size of the data grows. For large data-sizes, the methods take a proportionately larger time to complete. Hence, a method for insertion or removal of data that does not suffer from these limitations is required.

### Storage Block Management Data

The total amount of data in a storage-unit includes data stored in the storage-unit, and storage block management data.

‘Storage block management data’ is data required for maintaining the association of a number of storage blocks, or a number of ranges of addresses in the storage blocks, with the logical address space.

In some cases, the storage-block management data is maintained along with the data in the storage unit. For instance, a node in a linked-list comprises a pointer to the next node in the linked-list. A node in a tree data structure includes a number of pointers to a number of sub-nodes. In other cases, the storage-management data is maintained separate from the data in the storage unit. In a FAT file system, a linked-list of FAT entries is maintained to track clusters allocated to a file.

### Types of Storage Units

Storage units are of many types, such as memory regions, data structures, and files.

### Memory Regions

Each process on a computer is provided with one or more memory regions for storage of data. For example, the system provides memory regions to maintain the process-stack or thread-stacks, one or more heaps, and the like. Many systems also provide special-purpose memory regions. Some memory systems also provide a memory region by allocating memory from a larger memory region. For example, the ‘malloc’ function in the C language is used to provide a memory region to an application.

Storage and retrieval of data in a memory region at random locations is quite efficient, and is usually accomplished in O (1), or constant time. However, insertion and removal of data is generally inefficient. On average, each insertion or removal operation requires O (n) time, i.e. time proportional to the size of the memory region. Sometimes, one or more of the alternative methods described above are used to accomplish insertion or removal of data.

### Data Structures

Some data structures provide efficient methods for accessing a data element, but do not provide the ability to efficiently insert or remove data elements. Some other data structures provide efficient methods to insert or remove a data element, but do not provide efficient methods for accessing the data elements, or suffer from other limitations. In addition, each data structure has its own disadvantages.

Arrays provide the ability to store and retrieve data elements at random locations at constant speed. A number of data elements at consecutive locations may be accessed in a single operation. However, arrays do not provide the ability to insert and remove data elements.

Growable-arrays, such as variable-length arrays and dynamic arrays, also provide the ability to store and retrieve data elements at random locations at constant speed. A number of data elements at consecutive locations may be accessed in a single operation. The ability to insert or remove data elements within a growable array is also provided. However, insertion and removal of data elements is inefficient. In a growable-array comprising n data elements, each insertion or removal takes, on average, O (n) time.

Arrays and growable arrays provide a contiguous address space for storing data elements. Hence, insertion and removal of data requires all data beyond the point of insertion or removal to be copied to new positions. Other data structures, such as linked-lists, partition the data into smaller fragments, and avoid the necessity to copy all data beyond the point of insertion or removal.

Linked lists provide efficient insertion and removal of data elements. Insertion of one or more consecutive data elements at a given location requires O (1) time. However, accessing a data element by its position requires O (n) time. Thus, linked-lists become progressively slower as more data elements are added.

Some balanced-trees, such as counted b-trees, provide efficient indexed access, requiring O (log n) time per access. However, storage, retrieval, insertion, or removal, of a data element by position, each requires O (log n) time. Insertion and removal of data elements is performed one data-element at a time. Storage, retrieval, insertion, or removal of m elements by index requires m times O (log n) time.

### File Systems

In general, file systems provide the ability to efficiently access data elements stored in a file by their index or position. They either do not provide the ability to insert or remove data in a file, or provide inefficient methods for insertion or removal of data.

Usually, file systems provide data-access by reading data into cluster-sized memory buffers. If data in a memory-buffer is modified, the modified data is not immediately written to disk. Instead, the memory-buffer is marked as ‘dirty’. Dirty memory-buffers are later written to disk when the file is closed.

In a memory-mapped file, the memory buffers are mapped as pages in a virtual memory region. When data in a virtual memory region is modified, the memory management unit marks the page or pages holding the data as ‘dirty’. Dirty pages are later committed to disk by writing the entire memory-buffer to the disk. A method for insertion and removal of data in a file in a flash-based file system is described in Patent Application Numbers PCT/US2007/088165 and WO/2007/19174 A2. This method suffers from a number of infirmities and disadvantages, as discussed below.

The file system is designed to work on systems that use re-programmable flash semiconductor memory. The file system uses a continuous logical address space. When data is modified, the entire cluster or block is not modified. Instead, data is updated in small chunks, depending on the number of bytes modified. Data is stored in the order received from the host, regardless of the order of the offsets of that data within the file. The techniques used are incompatible with other storage-media. The techniques are also not compatible with virtual memory systems or memory-mapped files.

The file system stores the data in a number of variable-sized data-groups. A number of data objects received from a file are written at consecutive positions in a memory-page, regardless of the order of the offsets of that data in the file. A file-index table (FIT) is used to maintain storage block management data in a sequence of a number of index-entries. Each data-group is represented by an entry in the FIT. The entry comprises ‘file-offset’ and ‘memory-address’ fields, and optionally a ‘length’ field, relating to each data-group.

As data from the host is being written, a new data-group is begun whenever there is a discontinuity either in the logical offset addresses of the data file, or in the address space to which the data is being stored. When the write involves an update of existing data, an existing data-group is split and a new data-group is created, thereby creating two additional data-groups. The FIT thus contains a large number of entries for each file. Updating data in an existing file most commonly results in data within a given address range of an existing file being replaced by a like amount of updated data, so the offsets of other data in the file usually need not be replaced. Updating existing data in a file is thus performed efficiently. Further, when garbage-collection is performed on a block, the contents would entirely fit within a new block.

However, when the operation involves insertion or removal of data in the file, all index-entries in the FIT beyond the point of insertion or removal are required to be modified after each insertion or removal. A new data group is created for each operation involving insertion. Each insertion or removal also causes a number of additional entries to be added in the FIT. Thus, each insertion or removal operation requires O (n) time. Insertion of n records requires O (n²) time. The operation becomes progressively inefficient as the file becomes larger. Insertion or removal of data also causes FIT entries to be repeatedly re-written, which would result in early failure of the flash-memory. If a number of small data-groups are inserted in the file, the amount of storage space required to store the FIT may exceed than the amount of data in the file.

Insertion of data in a block also causes fragmentation of a number of blocks beyond the point of insertion, thereby requiring frequent de-fragmentation of the file. Even when garbage-collection is performed on a block, the data remains fragmented as the contents would fail to entirely fit within a new block.

The total data in a storage-unit includes data stored at the logical address space, and the storage-block management data. When such total data in the file is considered, the method does not enable insertion or removal of data without modifying large amounts of data beyond the point of insertion or removal.

Thus, if a number of records are inserted into a sorted array using ‘insertion sort’ stored in a file in the file system, a new FIT entry is created for each record inserted. Further all FIT entries beyond the point of insertion are also modified after each insertion. Thus, on average, insertion of 100 records results in 5000 modifications to FIT entries. Insertion of 1000 records results in 500000 modifications to FIT entries. The time required to perform the operation increases exponentially as the number of records in the file increases.

Consequently, the methods of insertion or removal of data described above in the conventional art are inefficient and impractical.

### SUMMARY

In view of the deficiencies in the conventional methodologies for the insertion and removal of data, the disclosed subject matter provides a system and method for efficiently utilizing the storage capacity present in each storage block of a storage unit. The disclosed subject matter also provides fast relocation, insertion and removal techniques associated with the data.

According to one aspect of the disclosed subject matter, a methodology for inserting, removing or relocating one or more data elements at a predetermined logical address in a series of data-elements in a storage unit is provided. In one aspect, the storage unit can be, for example, a memory region is a memory system or a file in a file system.

According to another aspect of the disclosed subject matter, a methodology for efficiently utilizing data processing device time of a data processing device associated with the data storage system is provided. Another aspect of the disclosed embodiments provides easier manipulation, storage, and transmission of data.

According to one embodiment of the disclosed subject matter, data in a storage unit is moved to higher or lower addresses by remapping the storage blocks or the data in the storage blocks to higher or lower addresses, thereby moving data within the address space without physically accessing data so moved. The storage blocks in a storage unit may be of unequal capacities. According to another embodiment of the disclosed subject matter, the storage blocks in a storage unit may contain a spare capacity.

According to an embodiment of the disclosed subject matter, the method includes insertion of data in a storage unit by insertion of data elements in a storage block in the storage unit, insertion of one or more storage blocks in the storage unit, or both.

According to another embodiment of the disclosed subject matter, the method includes removal of data elements from a storage unit by removal of data elements from a storage block in the storage unit, removal of one or more storage blocks in the storage unit, or both.

According to yet another embodiment of the disclosed subject matter, the method includes modification of data by replacement of a storage block in the storage unit, or rearrangement of storage blocks in the storage unit.

### BRIEF DESCRIPTION OF THE DRAWINGS

Various embodiments of the disclosed subject matter will hereinafter be described in conjunction with the appended drawings provided to illustrate and not to limit the presently disclosed subject matter, wherein like designations denote like elements, and in which:

FIGS. 1A, 1B, and 1C are schematic diagrams illustrating a structure of a data storage device, an association between a logical address space and a number of addresses in a number of storage blocks in a file system, and an association between a virtual address space and a number of addresses in a number of pages in a virtual memory system, in accordance with various embodiments of the disclosed subject matter.

FIG. 1D is a schematic diagram illustrating the structure of a data mapping module. FIG. 1E is a schematic diagram illustrating an alternative structure of the data mapping module.

FIG. 1F is a schematic diagram illustrating the structure of a virtual memory system in accordance with an embodiment of the disclosed subject matter. FIG. 1G is a schematic diagram illustrating the structure of a virtual memory system in accordance with another embodiment of the disclosed subject matter.

FIGS. 2A and 2B are schematic diagrams illustrating a logical representation of information, related to a storage unit, stored in a storage block management module, in accordance with an embodiment of the disclosed subject matter.

FIGS. 3A and 3B are schematic diagrams illustrating a logical representation of a storage unit and a storage block representation of the storage unit, in accordance with an embodiment of the disclosed subject matter.

FIGS. 4A, 4B, 4C, and 4D are schematic diagrams illustrating a logical representation of a storage unit; a storage block representation of a storage unit; a logical representation of the storage unit after insertion of data elements in storage unit; and an storage block representation of the storage unit after insertion of data elements in storage unit respectively, in accordance with an embodiment of the disclosed subject matter.

FIGS. 5A and 5B are schematic diagrams illustrating a logical representation of a storage unit and a logical representation of storage unit after the insertion of data elements in the storage unit, in accordance with another embodiment of the disclosed subject matter.

FIGS. 6A, 6B, 6C, and 6D are schematic diagrams illustrating a logical representation of a storage unit; a storage block representation of the storage unit; a logical representation of the storage unit after the removal of data elements from the storage unit; and a storage block representation of the storage unit after the removal of data elements from the storage unit respectively, in accordance with an embodiment of the disclosed subject matter.

FIGS. 7A, 7B, 7C, and 7D are schematic diagrams illustrating a logical representation of a storage unit; a storage block representation of the storage unit; a logical representation of the storage unit after replacing a storage block; and a storage block representation of the storage unit after replacing a storage block respectively, in accordance with an embodiment of the disclosed subject matter.

FIGS. 8A and 8B are schematic diagrams illustrating a logical representation of a storage unit and a logical representation of the storage unit after replacing a storage block respectively, in accordance with another embodiment of the disclosed subject matter.

FIGS. 9A and 9B are schematic diagrams illustrating a logical representation of a storage unit and a logical representation of the storage unit comprising some storage blocks shared with storage unit, and after replacing a storage block, respectively, in accordance with another embodiment of the disclosed subject matter.

FIGS. 10A and 10B are schematic diagrams illustrating a logical representation of a storage unit and a logical representation of the storage unit after rearrangement of storage blocks within the storage unit respectively, in accordance with an embodiment of the disclosed subject matter.

FIGS. 11A and 11B are schematic diagrams illustrating a logical representation of storage block and a logical representation of the storage block after insertion of data elements respectively, in accordance with an embodiment of the disclosed subject matter.

FIGS. 12A and 12B are schematic diagrams illustrating a logical representation of a storage block and a logical representation of the storage block after removal of data elements respectively, in accordance with an embodiment of the disclosed subject matter.

FIG. 13 depicts the structure of a metafile in accordance with an embodiment of the disclosed subject matter.

FIG. 14 depicts a flowchart illustrating a method for inserting data elements in a storage unit, in accordance with an embodiment of the disclosed subject matter.

FIG. 15 depicts a flowchart illustrating a method for removing data elements from a storage unit, in accordance with an embodiment of the disclosed subject matter.

FIG. 16 depicts a flowchart illustrating a method for replacing a storage block in a storage unit, in accordance with an embodiment of the disclosed subject matter.

### DESCRIPTION OF THE DISCLOSED EMBODIMENTS

The disclosed subject matter provides a data storage device for storing and retrieving data in computing devices. The data storage-device stores data in storage units. In accordance with an embodiment of the disclosed subject matter, a storage unit includes a number of storage blocks, a logical address space, and a data mapping module. The storage blocks have a number of addresses for storing data elements.

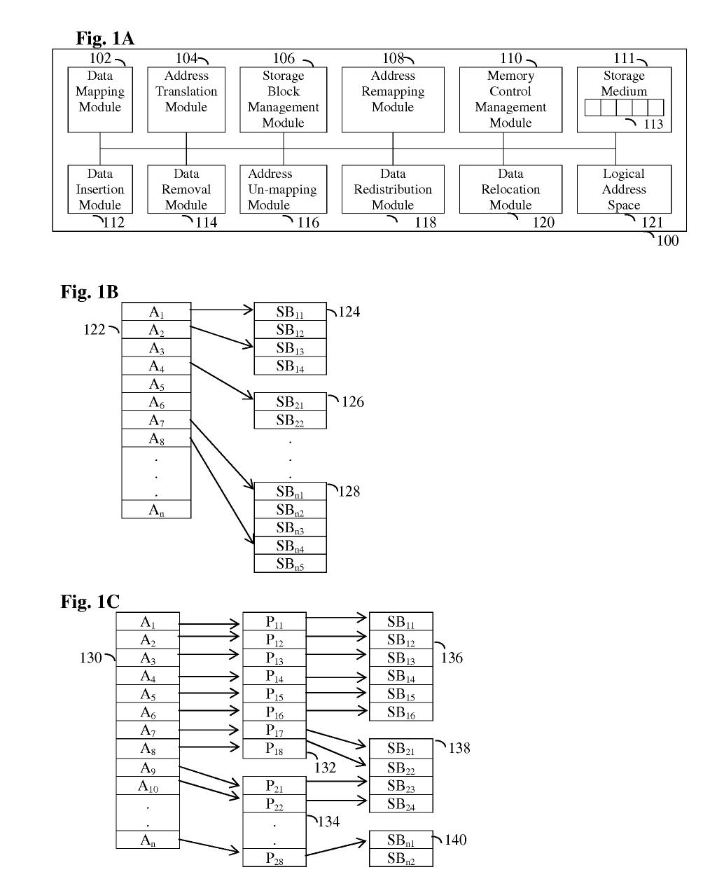

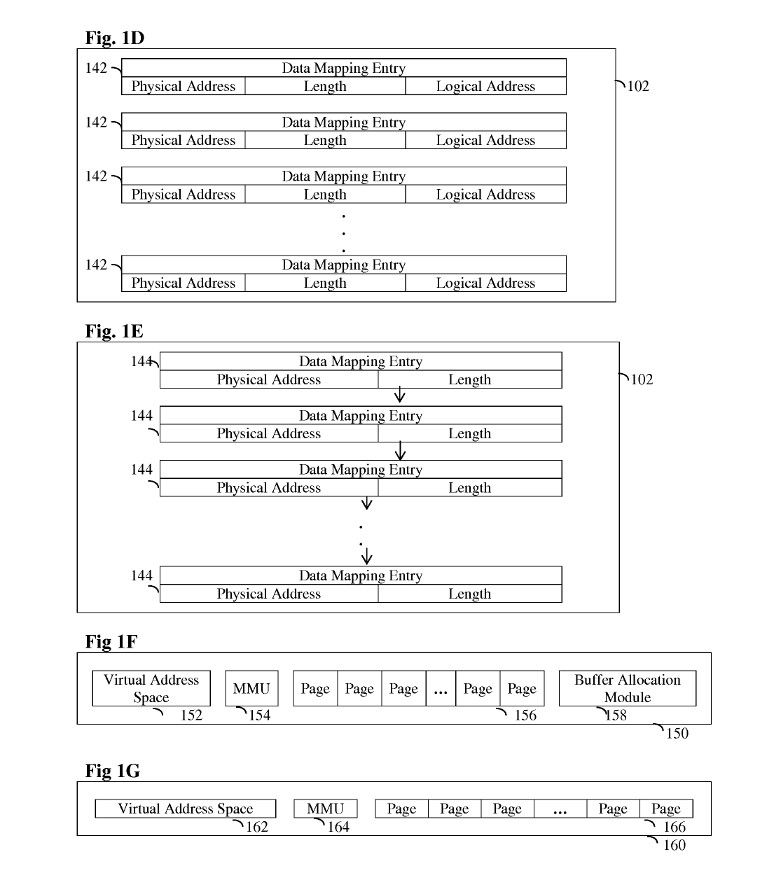

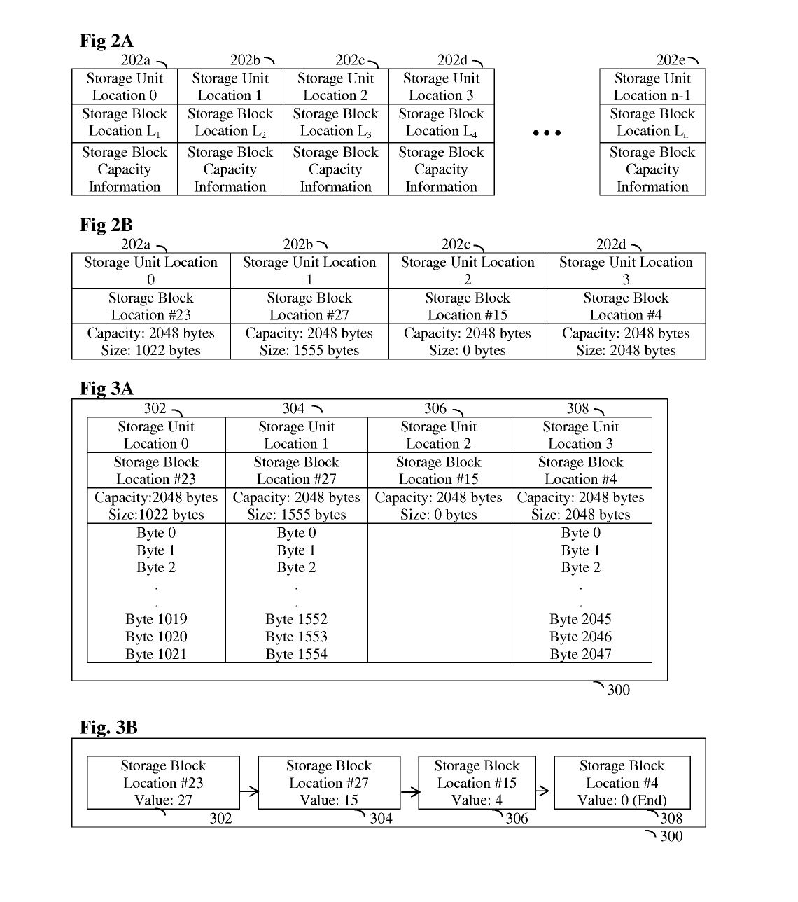

The data-mapping module maps or associates some or all addresses in storage blocks to logical addresses in the storage unit. The data mapping module maintains storage block management data of the storage unit. The data mapping module will be described in detail in FIG. 1A.

In accordance with an embodiment of the disclosed subject matter, the capacity of a storage block in the storage unit may not be equal to the capacity of another storage block in the storage unit. The capacity of a storage block may also vary from time to time. The capacity of a storage block is the number of data elements that the storage block is capable of storing.

In accordance with an embodiment of the disclosed subject matter, the effective sizes of the storage blocks in the storage unit may not be equal. The effective size of a storage block may also vary from time to time. The effective size of a storage block is the number of data elements in the storage block that are associated with addresses in the logical address-space.

In accordance with an embodiment of the disclosed subject matter, some or all storage blocks in the storage unit may possess spare-capacity. Further, the spare-capacity in a storage block may not be equal to the spare-capacity of another storage block in the storage unit. The spare-capacity of a storage block is the number of additional data elements that the storage block is capable of storing or representing. The spare-capacity may be used to insert additional data in the storage block. The spare-capacity in a storage block may be increased by removing some existing data in the storage block, or by dissociating some addresses in the storage block from logical addresses.

FIGS. 1A, 1B, and 1C are schematic diagrams illustrating a structure of a data storage device, an association between logical address space and a number of addresses in a number of storage blocks in a storage unit, and an association between a virtual address space and a number of pages in a virtual memory system in accordance with various embodiments of the present invention.

Data storage device 100 includes a data mapping module 102, an address translation module 104, a storage block management module 106, an address remapping module 108, a memory control management module 110, a number of storage blocks 113 in a storage medium 111, a data insertion module 112, a data removal module 114, an address un-mapping module 116, a data re-distribution module 118, a data relocation module 120, and a logical address space 121.

In accordance with an embodiment of the disclosed subject matter, the data storage device 100 is a file system. In the file system, a file is considered to be a storage unit and each cluster is considered to be a storage block.

In accordance with an embodiment of the disclosed subject matter, the data storage device 100 is a virtual memory system. In the virtual memory system, a memory region is considered to be a storage unit and each page included in the memory region is considered to be a storage block.

In accordance with an embodiment of the disclosed subject matter, the data storage device 100 is a data structure. The data structure provides a number of logical addresses for storing data elements. The data structure provides methods to store, retrieve, insert and remove data elements by their logical addresses, or indexes. The data-structure has a number of nodes for storing data. The data structure is considered a storage-unit, and each node is considered a storage-block.

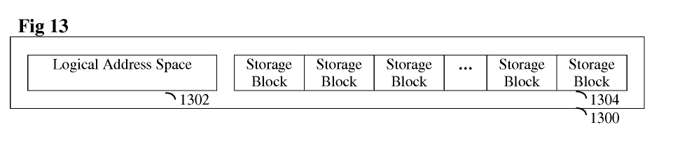

In accordance with an embodiment of the disclosed subject matter, the data storage device 100 is a metafile. The metafile provides methods to store, retrieve, insert, and remove data elements by their logical addresses, or indexes. In a metafile, a number of storage-units are used as storage-blocks. The metafile provides a logical address space for storing data elements, which is the accumulation of the logical address spaces of the storage-blocks. The metafile will be further described in FIG. 13.

The data mapping module 102 maps some or all addresses in a storage block to logical addresses. The data mapping module maintains data to manage storage blocks in the storage unit. In accordance with an embodiment of the disclosed subject matter, each storage block includes a range of addresses. However, it should be understood that the disclosed subject matter may be configured so that each storage block includes a number of ranges of addresses, and each range of addresses in a storage block is mapped with a range of logical addresses. Each range of addresses in a storage block may include one or more addresses.

FIG. 1D shows the structure of the data mapping module 102 in accordance with an embodiment of the disclosed subject matter. Accordingly, the data mapping module 102 maintains a list of data mapping entries 142 for associating the addresses in the storage block with logical addresses. Each data mapping entry maintains ‘physical address’, ‘length’, and ‘logical address’ fields. Data elements in the storage block corresponding to ‘physical address’ and ‘length’ fields are mapped to the range of logical addresses indicated by the ‘logical address’ field. The number of addresses in a range of addresses in the storage block that are mapped to logical addresses can be changed, by increasing or decreasing the value in the ‘length’ field. Further, by modifying the ‘logical address’ field, the logical addresses with which the addresses in the storage block are associated are changed, thereby relocating the data in the storage block to higher or lower logical addresses. Additional logical addresses are mapped to storage blocks by inserting additional data mapping entries in the data mapping module. Existing logical addresses are unmapped by removing a data mapping entry.

FIG. 1E shows the structure of the data mapping module 102 in accordance with another embodiment of the present invention. Accordingly, the data mapping module 102 maintains data mapping entries 144 relating to each storage unit in a sequence in a linked list. Each data mapping entry maintains ‘physical address’ and ‘length’ fields to indicate a range of addresses in a storage block. Data elements in the corresponding addresses in the storage block are mapped to logical addresses based on the cumulative value of the ‘length’ field of preceding data mapping entries in the sequence. Accordingly, by increasing or decreasing the value in the ‘length’ field, the number of logical addresses with which one or more addresses in the storage block are associated are changed. Further, data elements in one or more successive ranges of addresses in storage blocks are thereby relocated to new logical addresses. Data elements in a storage block may also be relocated by modifying the position of the data mapping entry in the sequence. Data elements in a storage block may also be relocated by inserting or removing data mapping entries in the sequence. As may be seen, only a few data mapping entries are required to be modified during insertion or removal of data in the storage-unit.

The address translation module 104 translates a logical address to the address of the associated data element in a storage block. The address translation module performs translation based on mapping provided by the data mapping module 102.

The storage block management module 106 manages allocation of storage blocks to a storage unit. A storage unit may have a number of storage blocks associated with it. Based on insertion or removal of data from the storage unit, a number of storage blocks are added to or removed from the storage unit. The storage block management module 106 maintains an association between the storage blocks and the storage unit. Further, during addition of a storage block, storage the block management module 106 provides a new storage block to be added, based on the availability of a new storage block. When a storage block is to be removed from the storage unit, the storage block management module 106 removes the storage block by updating the association between the storage block and the storage unit. Further, the storage block management module 106 stores information related to data storage capacity of all storage blocks corresponding to each storage unit. The information includes values related to capacity of the storage blocks, effective size of the storage blocks, and spare capacity of the storage blocks.

The address remapping module 108 dissociates an address in a storage block from a logical address and associates the address in the storage block with another logical address in the storage unit. In accordance with an embodiment of the disclosed subject matter, data in storage blocks may be re-mapped to higher or lower logical addresses, thereby moving some data elements in the storage unit to higher or lower logical addresses. The remapping is performed by the address remapping module 108 without physically accessing or copying the data so moved, and while retaining some other data elements at their existing logical addresses.

As a result of moving data elements within the logical address space, or for other reasons, one or more logical addresses may not be associated with any data elements at some point of time, thereby creating ‘holes’ in the logical address space. Also, for similar reasons, one or more logical addresses previously not associated with any data elements may be associated with data elements, thereby closing the holes in the logical address space.

The memory control management module 110 stores or retrieves a data element in a storage block at a predetermined address within the storage block.

The data relocation module 120 relocates one or more data elements stored in a storage unit from existing logical addresses to predetermined logical addresses within the storage unit by dissociating the address of the data elements in the storage blocks from their logical addresses, and associating the address in the storage block with one of the predetermined logical addresses. This is performed by the data relocation module 120 while retaining other data elements in the storage unit at their existing logical addresses.

The data insertion module 112 inserts one or more additional data elements at and subsequent to a predetermined logical address within an existing series of data elements stored in a storage unit. In accordance with an embodiment of the disclosed subject matter, one or more existing data elements stored at and subsequent to the predetermined logical address are relocated to higher logical addresses by re-mapping the addresses of the one or more existing data elements in the storage blocks to higher logical addresses, storing one or more additional data elements at a number of addresses in the storage blocks, and associating the addresses of the one or more additional data elements in the storage blocks at and subsequent to the predetermined logical address.

In accordance with an embodiment of the disclosed subject matter, before inserting one or more data elements at and subsequent to a logical address into a storage unit, a storage block and spare capacity of the storage block are identified. If a data element requires storage space that is less than or equivalent to the spare capacity of the storage block, the data element is inserted into the storage block. In case the data element requires storage space that is more than the spare capacity of the storage block, additional spare capacity is acquired. Additional spare capacity may be acquired in a storage block by re-distribution of data elements with other storage blocks in the storage unit. For example, one or more data elements in a storage block may be moved to another storage block if the other storage block possesses spare capacity. Additional spare capacity may also be acquired by insertion of one or more additional storage blocks in the storage unit, or by replacing a storage block with another storage block with a larger capacity. The data elements are then inserted into the appropriate storage block or storage blocks. The effective sizes of the storage blocks are updated based on the amount of data inserted. The re-distribution of data elements is performed by data the re-distribution module 118. The data re-distribution module 118 will be explained in detail later in the description.

The data removal module 114 removes one or more data elements from within a series of data elements stored at a predetermined logical address in a storage unit. In accordance with an embodiment of the disclosed subject matter, before removal of one or more data elements at and subsequent to a logical address in a storage unit, the appropriate storage block or blocks are identified. The data elements are removed from the storage block or blocks by dissociating the addresses of the data elements in the storage blocks from logical addresses with which the addresses are associated, thereby also possibly increasing the spare capacity in the storage blocks. If effective size of a storage block is reduced to null, the storage block is removed from the storage unit. Alternatively, a data element is removed by replacing the storage block with a new storage block of a smaller storage capacity, and copying data elements other than the data elements being removed into the new storage block. One or more data elements stored at and subsequent to the predetermined logical address are re-located to lower logical addresses by dissociating the addresses of the data elements in the storage block with the logical addresses of the data elements, and re-associating the addresses in the storage blocks with lower logical addresses.

The address un-mapping module 116 dissociates an address in a storage block in a storage unit from a logical address in the storage unit, while retaining an association between some addresses in the storage block with logical addresses.

Depending on the desired characteristics, storage medium 111 may be volatile memory or persistent memory. The storage medium may thus be RAM, a partition in a hard-disk, compact disk storage, flash semiconductor memory, and the like. File systems are sometimes implemented ‘on top of’ an existing file. Thus, the storage medium may be another file, a network resource, or any other device capable of storing data. The storage medium may also be a combination of one or more of the above.

If the data mapping module of FIG. 1D is used, operations on the data mapping module may become inefficient as the number of data mapping entries increases. The data mapping entries are then stored in a list that has lists of data mapping entries. That is, the data mapping entries are maintained in two or more levels, or in two or more partitions. Each list is associated with a logical address in the storage unit. Each data mapping entry in a list stores a logical address relative to the logical address with which the list is associated. This ensures that only a few data mapping entries are required to be modified when data is inserted or removed in the storage unit. This advantage is also realized if a storage unit is used as a storage block, such as in a metafile. This method may be extended further by maintaining a list of lists of lists, or a tree, of data mapping entries.

If the data mapping module of FIG. 1E is used, the data mapping module may be further extended to maintain a list of lists, or a list of lists of lists, or a tree, of data mapping entries. That is, the data mapping entries are maintained in two or more levels, or in two or more partitions. Each list is associated with a logical address in the storage unit. The logical address with which a data mapping entry is associated is calculated based on the logical address with which the list is associated, and the sum of the ‘length’ field in preceding data mapping entries. An advantage of this method is that it reduces the number of accesses required when translating a logical address. This advantage may also be realized if a storage unit is used as a storage block, such as in a metafile.

Thus, as described above, a number of methods for storage of storage block management data may be used. The location and format of maintaining storage block management data would vary from case to case.

The ability to maintain storage block management data without requiring that a large number of data mapping entries are modified during insertion or removal, as described above, would be particularly useful if incorporated in some types of storage systems, such as the file system in reprogrammable flash memory discussed previously.

In accordance with an embodiment of the disclosed subject matter, the storage block management data may be stored within the storage blocks. In accordance with another embodiment, the storage-block management data may be stored within its own storage location.

The data re-distribution module 118 redistributes data in some storage blocks in a storage unit by removing data elements from one storage block and inserting those data elements in another storage block. This is performed to increase or decrease the spare or used capacities among storage blocks. Data may also be re-distributed among storage blocks in order to provide more optimal alignment of data elements stored in a storage unit. The data re-distribution module 118 copies data elements from a set of addresses in a first storage block to a set of addresses in a second storage block in a storage unit. Further, the data re-distribution module 118 dissociates logical addresses associated with the set of addresses in the first storage block and associates the logical addresses with the set of addresses in the second storage block. Another advantage of data re-distribution during insertion and removal is that it allows storage block management data to be maintained efficiently.

Referring now to FIG. 1B, an association between a logical address space with a number of storage blocks in a storage unit is shown. A logical address space 122 is shown having a number of logical addresses A₁, A₂, A₃, and so on. Some or all logical addresses of the logical address space 122 have corresponding addresses in storage blocks 124, 126, and 128. Each storage block of the storage blocks 124, 126, and 128 has a variable capacity, a variable effective size and a variable spare capacity. A data element is stored at an address in a storage block. All addresses in storage blocks 124, 126, and 128 are not necessarily associated with a corresponding logical address in logical address space 122. Addresses SB₁₁ and SB₁₃ in storage block 124 are associated with corresponding addresses A₁ and A₂ in logical address space 122. Therefore, the effective size of storage block 124 is two Similarly, the effective size of storage block 126 is one, and the effective size of storage block 128 is two. When data elements are inserted into or removed from a storage block, associations between addresses in the storage block and logical addresses in the logical address space are modified. As described in FIG. 1A, the data mapping module 102 maps or associates some or all addresses in storage blocks in the device to the logical address space.

FIG. 1F shows a virtual memory system in accordance with an alternative embodiment of the disclosed subject matter. The virtual memory system provides a memory region. The memory region is a storage unit that has ability to store, retrieve, relocate, insert, and remove data elements in accordance with embodiments described above. Each memory region comprises a logical address space in the form of virtual address space 152 and a number of storage blocks in the form of pages 156. One or more addresses in the storage blocks are associated with logical addresses in accordance with the embodiments described above. The storage blocks in the virtual memory system possess variable capacity, variable effective size, and variable spare capacity, as described above. The virtual memory system also includes a data mapping module as described above.

The virtual memory system also includes a memory management unit (MMU) 154. The MMU 154 provides mapping of the data in the storage blocks to the logical address space using page table entries in a page table. Each page table entry represents a fixed-sized page-frame, and is capable of mapping a fixed sized memory buffer in physical memory to the logical address space. A page table entry comprises a ‘present-bit’, a ‘dirty-bit’, and a ‘page-address’.

The virtual memory system includes a memory buffer allocation module 158 which maintains a small pool of page-frame sized memory buffers, and is capable of providing a buffer when required, and of accepting a buffer into its pool when it is no more required.

When the present bit in a page table entry is set, the page address field provides the address of a page-frame sized memory buffer in physical memory. This address is used by the MMU to provide access to the data in the memory buffer using logical addresses. The addresses of the data in the memory buffer within the logical address space are determined by multiplying the page-frame size with the position of the page table entry in the page table.

Each address in the memory buffer is also associated with an address in the storage blocks. The memory buffer has a fixed number of addresses. The address in the storage block that is associated with an address in the memory buffer is determined taking into account the effective sizes of the successive pages, as previously described.

Before using a memory buffer, the memory buffer is filled with data from the storage blocks. Similarly, when data in a memory buffer is modified, the memory buffer is committed to the storage blocks. The logical addresses in the logical address space are used to find the associated addresses within the storage blocks, and this information is used to copy data from the storage blocks to the memory buffer, or to copy data from memory buffer to the storage blocks.

To start with, the ‘present-bit’ of all page table entries relating to the memory region are cleared or reset. When a data element is accessed for reading or writing at an address in the logical address space in the memory region, the virtual memory system accesses the relevant page table entry in the page table. If the present bit in the page table entry is not set, a page fault occurs and the read or write operation in progress is suspended. When a page fault occurs, a memory buffer is allocated by the memory buffer allocation module. This memory buffer is filled with data by copying the data from one or more storage blocks as described above. The memory buffer is mapped by writing the address of this memory buffer in the ‘page-address’ field, clearing the ‘dirty-bit’ field, and setting the ‘present-bit’ field in the page table entry. The read or write operation is then resumed.

During a write operation, the virtual memory system sets the ‘dirty-bit’ in the page table entry. A memory buffer mapped at a page table entry with the dirty bit set may be committed by storing its contents to the storage blocks, and clearing the dirty-bit. If the allocation module does not have any memory buffers in its pool, the virtual memory system un-maps some memory buffers already mapped to page table entries by committing memory buffers, clearing the ‘present’ bit in the page table entry, and returning the memory buffers to the allocation module.

The virtual memory system provides for relocation, insertion and removal of data in the memory region. Before relocation, insertion or removal of data, the relevant memory buffers of the memory region are committed and unmapped. Relocation, insertion or removal of data elements within the storage blocks is performed in accordance with the various embodiments described herein. Subsequently, when a data element is accessed for reading or writing in the memory region, a page fault occurs, and a memory buffer is mapped again as described above. The relocated data in the memory region is mapped and accessed at their new virtual addresses. The newly inserted data elements in the memory region are mapped to the appropriate offsets in the logical address space. Similarly, data elements removed are no longer accessible in the memory region.

Referring now to FIG. 1C, an association between a logical address space and a number of addresses in a number of pages in a virtual memory system is shown. A logical address space 130 is associated with storage blocks 136, 138, and 140. Memory buffers 132 and 134 are used to provide access to the data in the storage blocks as and when necessary. For example, a data element stored at an address SB₁₂ in storage block 136 may be associated with an address A₂ and accessed through address P₁₂ of memory buffer 132. Each address of logical address space 130 has a corresponding address in storage blocks 136, 138, and 140.

Each storage block of storage blocks 136, 138, and 140 has a variable capacity, a variable effective size and a variable spare capacity. A data element is stored at an address in a storage block. All data elements stored at addresses in storage blocks 136, 138, and 140 are not necessarily associated with a corresponding address in logical address space 130. When data elements are relocated, inserted into or removed from a storage block, associations between addresses in the storage block and addresses in the logical address space are modified. As described in FIG. 1A, data mapping module 102 maps or associates some or all addresses in storage blocks in the device to the logical address space, through page tables. As described in FIG. 1B, the insertion or removal of data elements is dependent on effective size and spare capacity available in the storage block.

FIG. 1G shows a virtual memory system in accordance with another embodiment of the disclosed subject matter. The virtual memory system provides a memory region for storing data. The virtual memory system provides methods for reading and writing to a memory location, and for relocation, insertion and removal of data at a memory location in the memory region, in accordance with embodiments described above.

The memory region includes a logical address space in the form of virtual address space 162. The memory region also includes a data mapping module described above.

The memory region also comprises a memory-management unit MMU 164, which is capable of mapping a number of variable sized pages to the logical address space. Some MMUs, such as the MMUs described in commonly owned patent application no. PCT/IN2010/000641, provide the capability for mapping a number of variable-sized pages to the logical address space, and are suitable for being used.

The memory region also includes a number of variable-sized pages 166 in a sequence. A number of pages are mapped to the virtual-memory region from time to time. The virtual address to which a page is mapped is determined using the data mapping module described previously. If the ‘present bit’ in a page-table-entry is not set when data is accessed for reading or writing, a page fault is generated and the appropriate page is mapped to the logical address space.

The virtual memory system provides for relocation, insertion and removal of data in the memory region. Before relocation, insertion or removal of data, the relevant pages of the memory region are committed and unmapped. Data is inserted into the pages by using spare capacity in a page. A number of pages are also inserted, removed or replaced in the list of pages, as required, as previously described. In order to facilitate relocation, insertion, or removal of data, a page may be split into two or more pages. Similarly, two or more pages may be merged into a single page.

Subsequently, when a data element is accessed for reading or writing in the memory region, a page fault occurs, and a page is mapped again as described above. The relocated data in the memory region is mapped and accessed at their new addresses in the logical address space. The newly inserted data elements in the memory region are mapped to the appropriate offsets in the logical address space, and existing data elements at virtual addresses subsequent to the virtual address at which data is inserted are mapped at higher logical addresses in the logical address space Similarly, data elements removed are no longer accessible in the memory region, and existing data elements at addresses subsequent to the logical address at which data is removed are mapped to lower logical addresses in the logical address space.

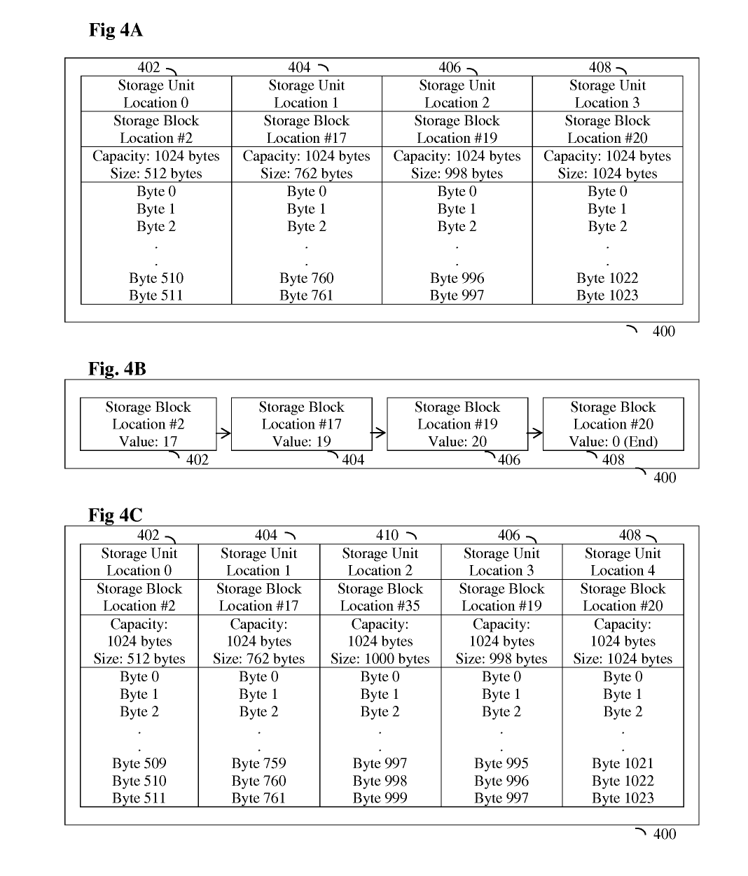

FIGS. 2A and 2B are schematic diagrams illustrating information related to a storage unit stored in storage block management module 106, in accordance with an embodiment of the disclosed embodiments. As described in conjunction with FIG. 1, the capacity of storage block, effective size of storage block, and the spare capacity of individual storage blocks of a storage unit may vary. The storage block management module 106 stores information related to data storage capacity of all storage blocks corresponding to each storage unit.

Referring to FIG. 2A, the information includes information blocks 202a, 202b, 202c, 202d, and 202e, hereinafter collectively referred to as information blocks 202, and individually referred to as information block 202. Each information block 202 has two values. The first value relates to location of a storage block in a storage medium. The second value relates to storage capacity of the corresponding storage block. Information block 202a corresponds to storage unit location 0 and storage block location L₁ indicates that the first information block in a sequence of storage blocks in the storage unit is mapped to storage block location L₁. Similarly, storage unit locations 1, 2, 3 and (n-1) are mapped to storage block location L₂, L₃, L₄, and Lₙ. Further, each information block 202 includes information related to storage capacity of the corresponding storage block.

Referring now to FIG. 2B, information related to an exemplary storage unit stored in storage block management module 106 is shown. Information blocks 202a, 202b, 202c, and 202d correspond to storage unit locations 0, 1, 2, and 3, which are mapped to storage block locations 23, 27, 15, and 4 respectively. As shown, the storage blocks are of equal storage capacity i.e. 2048 bytes. However, effective sizes of the storage blocks are 1022, 1555, 0, and 2048 bytes respectively.

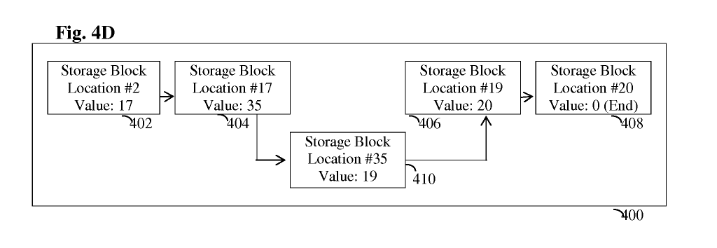

FIGS. 3A and 3B are schematic diagrams of an exemplary storage unit 300, with equal capacity and variable effective size storage blocks in accordance with an embodiment of the disclosed subject matter. Storage blocks 302, 304, 306, and 308 are logically stored at storage unit locations 0, 1, 2, and 3 and have storage block locations 23, 27, 15, and 4 respectively. Each storage block has a storage capacity of approximately 2048 bytes. Storage block 302 stores only 1022 bytes out of the capacity of 2048 bytes, thereby indicating a spare capacity of about 1026 bytes. Similarly, storage blocks 304, 306, and 308 store about 1555 bytes, about 0 bytes, and about 2048 bytes, indicating a spare capacity of about 493 bytes, about 2048 bytes, and about 0 bytes respectively. The storage block 302 stores about 1022 bytes that correspond to data positions 0 to 1021 in the storage unit 300. Similarly, storage block 304 stores about 1555 bytes that correspond to data positions 1022 to 2576 in the storage unit 300. Storage block 306 is empty. Storage block 308 stores about 2048 bytes that correspond to data positions 2577 to 4624 in the storage unit 300.

Referring to FIG. 3B, a schematic diagram illustrating a storage block representation of storage unit 300 according to one embodiment is shown. A sequence starts with storage block 302 corresponding to storage unit location 0 in storage unit 300. Storage block 302 is mapped to storage block location 23. Each storage block of the sequence stores a value of storage block location of the next storage block in the sequence. For example, storage block 302 corresponding to storage unit location 0 stores a value of storage block location of storage block 304 corresponding to storage unit location 1, and so on. Thus, storage block location 23 includes a value of storage block location 27; storage block location 27 includes a value of storage block location 15; and so on.

The disclosed subject matter will hereinafter be described in conjunction with a logical representation, as well as a storage block representation of a storage unit. It is to be understood that the information, related to the storage unit, stored in various modules in the data storage device 100, explained in detail in conjunction with FIG. 1, is suitably modified in accordance with the modification of the storage unit. Further, various embodiments of the disclosed subject matter will be described in conjunction with storage units including storage blocks with equal storage capacity. It should be understood that various embodiments of the disclosed subject matter are equally applicable to a storage unit including variable-capacity storage blocks. The particular, values of storage capacities, effective size and spare capacities, as indicated hereinafter, are only for illustrative purposes and are in no way intended to limit the scope of the disclosed subject matter.

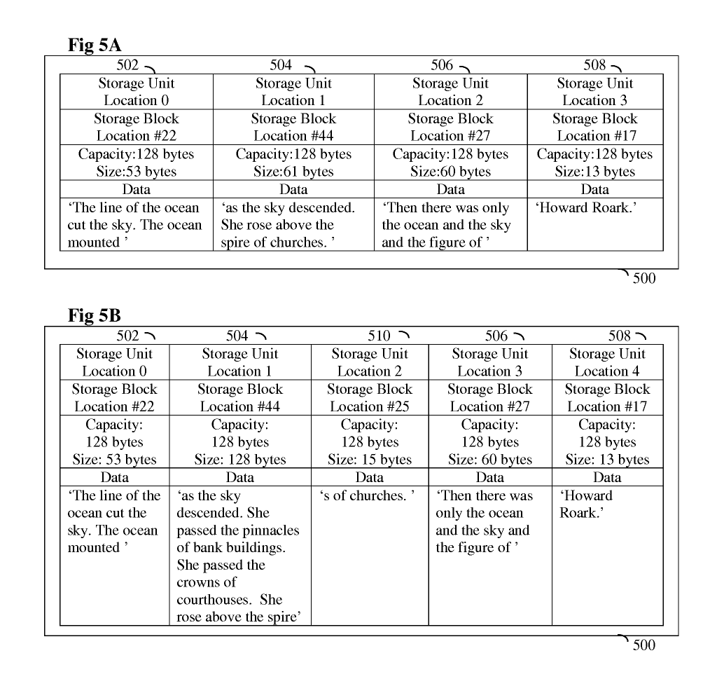

FIGS. 4A, 4B, 4C, and 4D are schematic diagrams illustrating a logical representation of a storage unit 400; a storage block representation of a storage unit 400; a logical representation of the storage unit 400 after insertion of data elements in storage unit 400; and a storage block representation of the storage unit 400 after insertion of data elements in storage unit 400 respectively, in accordance with an embodiment of the disclosed subject matter.

Referring to FIG. 4A, storage unit 400 includes four storage blocks 402, 404, 406, and 408 arranged in a sequence. Storage blocks 402, 404, 406, and 408 store about 512, 762, 998, and 1024 bytes of data respectively. Further, storage blocks 402, 404, 406, and 408 are mapped to storage block locations 2, 17, 19, and 20 in a storage medium.

Referring to FIG. 4B, a schematic diagram illustrating a storage block representation of storage unit 400 is shown. A sequence starts with storage block 402 corresponding to storage unit location 0 in storage unit 400. Storage block 402 is mapped to storage block location 2. Each storage block of the sequence stores a value of the storage block location of the next storage block in the sequence. For example, storage block 402 corresponding to storage unit location 0 stores the value of storage block location of storage block 404 corresponding to storage unit location 1, and so on. Thus storage block location 2 includes the value of storage block location 17; storage block location 17 includes the value of storage block location 19; and so on.

Referring to FIG. 4C, a logical representation of the storage unit 400 after insertion of data elements in storage unit 400 is shown. If the data elements are to be inserted in a storage unit, a storage block in which the data is to be inserted is identified. In the example, during insertion of data elements, storage block 404 is identified as the storage block at which the data is to be inserted. The storage capacity required to store the data elements to be inserted exceeds the spare capacity of the storage block 402 and thus, storage block 410 is inserted after storage block 404 in the sequence of storage blocks in storage unit 400.

Referring now to FIG. 4D, a sequence of storage blocks in the storage unit 400 after insertion of data elements in storage unit 400 is shown. The sequence of the storage blocks in storage unit 400 is appropriately modified to insert one or more storage blocks in the storage unit 400. Storage block 404 is updated to store the value of the storage block location of storage block 410 and storage block 410 is updated to store value of the storage block location of storage block 406.

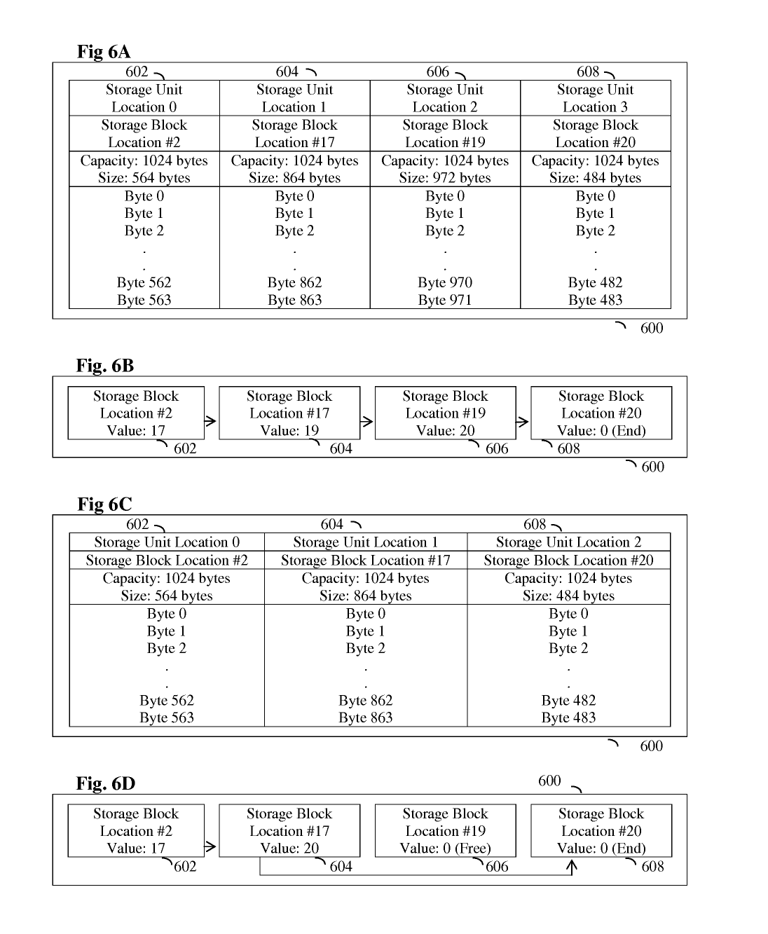

FIGS. 5A and 5B are schematic diagrams illustrating a logical representation of a storage unit 500 and a logical representation of storage unit after the insertion of data elements in the storage unit 500, in accordance with another embodiment of the disclosed subject matter.

Referring to FIG. 5A, storage unit 500 contains four storage blocks 502, 504, 506, and 508 arranged in a sequence. Each storage block has a storage capacity of 128 bytes. Storage blocks 502, 504, 506, and 508 are located in a storage medium at storage block locations 22, 44, 27, and 17, and store about 53, 61, 60, and 13 bytes of data respectively.

Referring now to FIG. 5B, a logical representation of storage unit after the insertion of data elements in the storage unit 500 is shown. In the example, storage block 504 is identified as the storage block in which the data is to be inserted. During insertion of data elements in the storage unit 500, the spare capacity of the storage blocks may be utilized. As the effective size of storage block 504 is about 61 bytes, when new data is inserted, the spare capacity of storage block 504 is utilized first. As the spare capacity of the storage block 504 is entirely utilized, a new storage block is inserted in the sequence of storage blocks. Thus, a new storage block 510 is inserted. Storage block 510 stores the remaining 15 bytes of data. The inserted data elements, therefore, are distributed among storage blocks 504 and 510. The new storage block 510 is located in a storage medium at storage block location 25.

When a new storage block is inserted in the storage unit, the sequence of the storage blocks is appropriately modified. The identified storage block 504 is updated to store the value of the storage block location 25 corresponding to the new storage block 510 and the new storage block 510 is updated to store value of the storage block location 27 stored in the identified storage block 504 before the insertion of data elements.

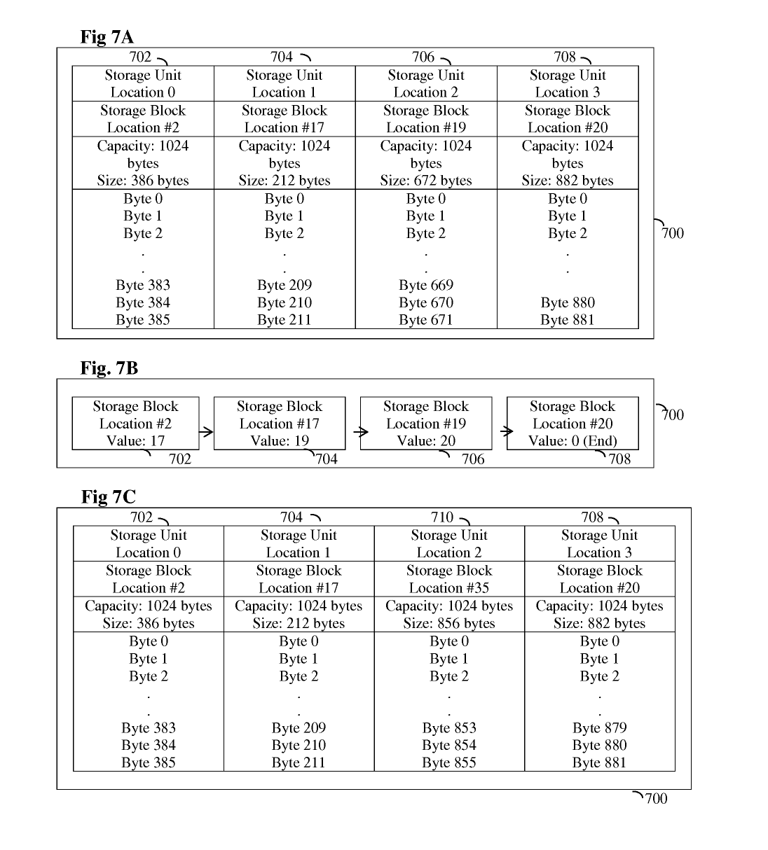

FIGS. 6A, 6B, 6C, and 6D are schematic diagrams illustrating a logical representation of a storage unit 600; a storage block representation of the storage unit 600; a logical representation of the storage unit 600 after the removal of data elements from the storage unit 600; and a storage block representation of the storage unit 600 after the removal of data elements from the storage unit 600 respectively, in accordance with an embodiment of the disclosed subject matter.

Referring to FIG. 6A, storage unit 600 is an exemplary storage unit containing four storage blocks 602, 604, 606, and 608 arranged in a sequence. Each storage block has a storage capacity of about 1024 bytes of data, and storage blocks 602, 604, 606, and 608 have an effective size of about 564, 864, 972, and 484 bytes respectively. Further, storage blocks 602, 604, 606, and 608 are located in a storage medium at storage block locations 2, 17, 19, and 20 respectively.

Referring to FIG. 6B, a schematic diagram illustrating a storage block representation of storage unit 600 is shown. The sequence starts with storage block 602 corresponding to storage unit location 0 in storage unit 600. Storage block 602 is mapped to storage block location 2. Each storage block of the sequence stores a value of the storage block location of the next storage block in the sequence. For example, storage block 602 corresponding to storage unit location 0 stores the value of storage block location of storage block 604 corresponding to storage unit location 1, and so on. Thus, storage block location 2 includes the value of storage block location 17; storage block location 17 includes the value of storage block location 19; and so on.

Referring to FIG. 6C, a logical representation of the storage unit 600 after the removal of data elements from the storage unit 600 is shown. During removal of data elements from a storage unit, a storage block from which the data is to be removed is identified and the data elements are removed from the storage block. In case after removal of data elements, the effective size of a storage block becomes null, the storage block is removed from storage unit 600. When a storage block is removed from storage unit 600, the sequence of the storage blocks is appropriately modified. The removed storage block is available to be allocated to another storage unit in the data storage device 100, as and when required.

In the example, during removal of data elements, storage block 606 is identified as the storage block from which the data is to be removed. As the effective size of storage block 606 after removal of data becomes null, storage block 606 is removed from the sequence of storage blocks in storage unit 600. After removal of storage block 606, storage block 604 is updated to point to storage block 608.

Referring to FIG. 6D, a storage block representation of the storage unit 600 after the removal of data elements from the storage unit 600 is shown. The sequence of the storage blocks in storage unit 600 is appropriately modified to remove one or more storage blocks in the storage unit 600. Storage block 604 is updated to store the value of the storage block location of storage block 608.

In case the combined effective size of one or more storage blocks is less than the storage capacity of a single storage block, the data elements in the one or more storage blocks are moved into a single storage block and the remaining storage blocks with null used storage capacity are removed from the storage unit. For example, a first storage block and a second storage block can both have a storage capacity of about 1024 bytes. The first storage block has an effective size of about 200 bytes and the second storage block has an effective size of about 256 bytes. The 256 bytes of the second storage block are added with the 200 bytes of the first storage block. Therefore, the first storage block has an effective size of about 456 bytes and the second storage block is removed.

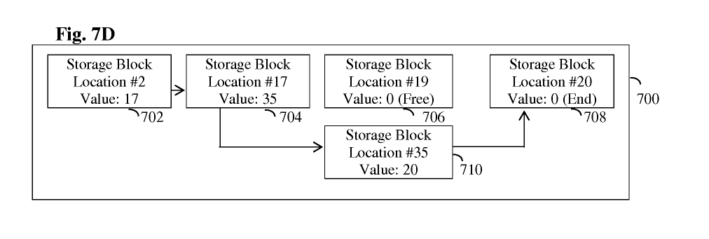

FIGS. 7A, 7B, 7C, and 7D are schematic diagrams illustrating a logical representation of a storage unit 700; a storage block representation of the storage unit 700; a logical representation of the storage unit 700 after replacing a storage block; and a storage block representation of the storage unit 700 after replacing a storage block respectively, in accordance with an embodiment of the disclosed embodiments.

Referring to FIG. 7A, storage unit 700 is an exemplary storage unit containing four storage blocks 702, 704, 706, and 708 arranged in a sequence. Each storage block has a storage capacity of 1024 bytes of data, and storage blocks 702, 704, 706, and 708 have an effective size of 386, 212, 672, and 882 bytes respectively. Further, storage blocks 702, 704, 706, and 708 are located in a storage medium at storage block locations 2, 17, 19, and 20 respectively.

Referring to FIG. 7B, a schematic diagram illustrating a storage block representation of a storage unit 700 is shown. The sequence starts with storage block 702 corresponding to storage unit location 0 in storage unit 700. Storage block 702 is stored at physical storage location 2. Each storage block of the sequence stores a value of the storage block location of the next storage block in the sequence. For example, storage block 702 corresponding to storage unit location 0 stores the value of storage block location of storage block 704 corresponding to storage unit location 1, and so on. Thus, storage block location 2 includes the value of storage block location 17; storage block location 17 includes the value of storage block location 19; and so on.

Referring to FIG. 7C, a logical representation of the storage unit 700 after the replacement of storage block in the storage unit 700 is shown. During replacement of storage block in a storage unit, a storage block which is to be replaced is identified and the identified storage block is removed from the storage unit 700 and the replacement storage block is inserted in the storage unit 700. The sequence of the storage blocks is appropriately modified so that the replacement storage block replaces the identified storage block. In the example, during replacement, storage block 706 is identified as the storage block to be replaced and it is replaced with storage block 710. Thus, replacement is a combination of two steps: removal of a storage block from an appropriate position; and insertion of a storage block at the appropriate position.

Referring to FIG. 7D, a storage block representation of the storage unit 700 after the replacement of storage block from the storage unit 700 is shown. The sequence of the storage blocks in storage unit 700 is appropriately modified to remove storage block 706 and insert 710 in the storage unit 700. Storage block 704 is updated to store the value of the storage block location of storage block 710. Further, the value of the storage block location of storage block 708 is stored in storage block 710.

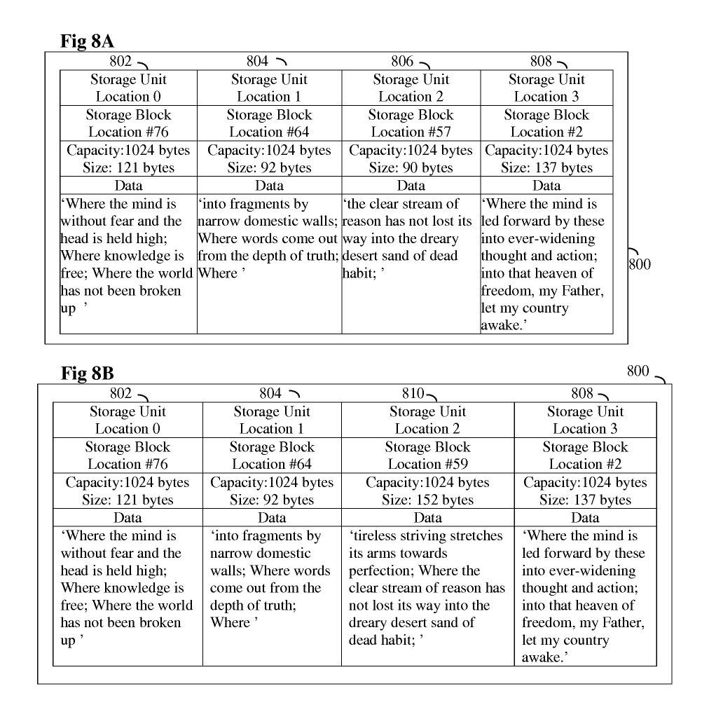

FIGS. 8A and 8B are schematic diagrams illustrating a logical representation of a storage unit 800 and a logical representation of the storage unit 800 after replacing a storage block respectively, in accordance with another embodiment of the disclosed subject matter.

Referring to FIG. 8A, storage unit 800 contains four storage blocks 802, 804, 806, and 808 arranged in a sequence. Each storage block has a storage capacity of 1024 bytes. Storage blocks 802, 804, 806, and 808 are located in a storage medium at storage block locations 76, 64, 57, and 2, and store about 121, 92, 90, and 137 bytes of data respectively. The sequence for storage blocks 802, 804, 806, and 808 is similar to the sequence of storage blocks 702, 704, 706, and 708 respectively as explained in FIG. 7D.

Referring now to FIG. 8B, a logical representation of storage unit after replacing storage block 806 in the storage unit 800 is shown. In the example, storage block 806 is identified as the storage block which is to be replaced. During replacement of storage block 806 in storage unit 800, storage block 806 is removed from the storage unit 800 and the replacement storage block 810 is inserted in the storage unit 800. The sequence of the storage blocks is appropriately modified so that the replacement storage block replaces the identified storage block.

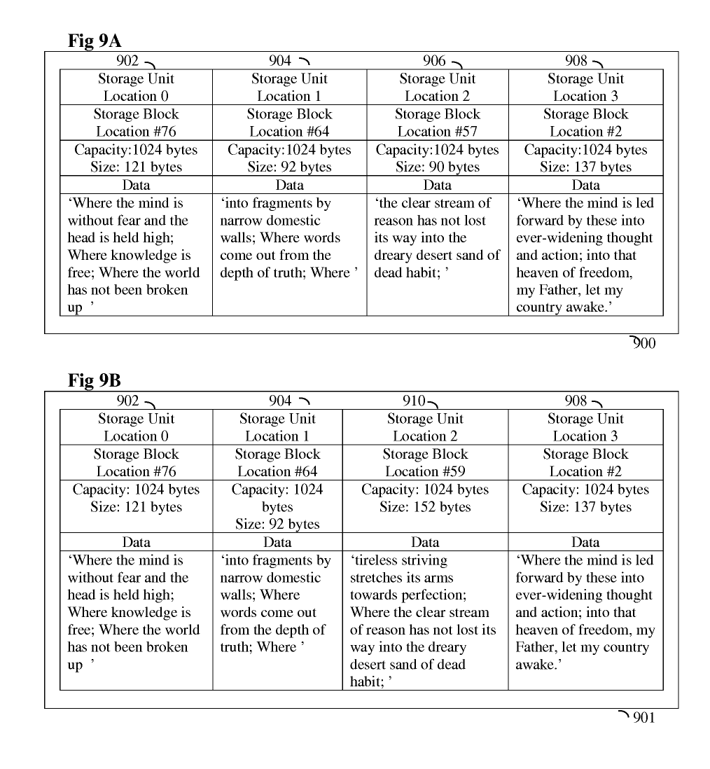

FIGS. 9A and 9B are schematic diagrams illustrating a logical representation of a storage unit 900 and a logical representation of the storage unit 901 comprising some storage blocks shared with storage unit 900, and after replacing a storage block, respectively, in accordance with another embodiment of the disclosed subject matter.

Referring to FIG. 9A, storage unit 900 contains four storage blocks 902, 904, 906, and 908 arranged in a sequence. Storage blocks 902, 904, 906, and 908 are located in a storage medium at physical storage locations 76, 64, 57, and 2, and store 121, 92, 90, and 137 bytes of data respectively.

Referring to FIG. 9B, another storage unit 901 contains four storage blocks 902, 904, 910 and 908. As may be seen, storage unit 901 is created using storage blocks 902, 904 and 908 already contained in storage unit 900, and a new storage block 910. Using this method, data elements are inserted into existing series of data elements by creating a new storage unit from some storage blocks in an existing storage unit. This method of insertion of data is analogous to the methods described in FIGS. 8A and 8B, but by creating a new storage unit.

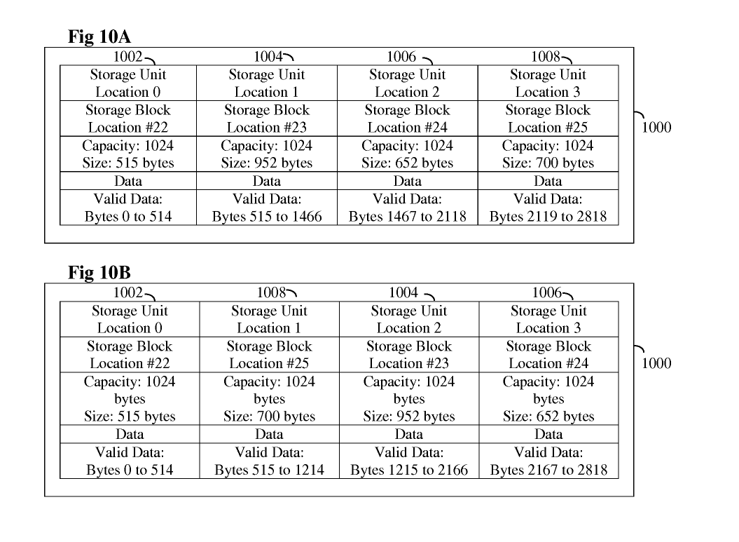

FIGS. 10A and 10B are schematic diagrams illustrating a logical representation of a storage unit 1000 and a logical representation of the storage unit 1000 after rearrangement of storage blocks within the storage unit 1000 respectively, in accordance with an embodiment of the disclosed embodiments.

Referring to FIG. 10A, storage unit 1000 is an exemplary storage unit containing four storage blocks 1002, 1004, 1006, and 1008 arranged in a sequence. Each storage block has a storage capacity of 1024 bytes of data, and storage blocks 1002, 1004, 1006, and 1008 have an effective size of about 515, 952, 652, and 700 bytes respectively. Further, storage blocks 1002, 1004, 1006, and 1008 are located in a storage medium at storage block locations 22, 23, 24, and 25 respectively.

Referring now to FIG. 10B, a logical representation of the storage unit 1000 after rearrangement of storage blocks within the storage unit 1000 is shown. As shown in FIG. 10B, storage blocks 1002, 1004, 1006, and 1008 are rearranged to form a rearranged sequence 1002, 1008, 1004, and 1006 in storage unit 1000.

Before rearrangement, storage block 1002, with storage block location 22, was followed by storage block 1004, with storage block location 23. After rearrangement, storage block 1002 with storage block location 22 is followed by storage block 1008 with storage block location 25. Further, storage block 1008 with storage block location 25 is followed by storage block 1004 with storage block location 23. Storage block which was located at storage unit location 3, after rearrangement is located at storage unit location 1, thereby shifting the locations of storage blocks located at storage unit locations 1 and 2 to storage unit locations 2 and 3 respectively. Thereby, some data in the storage-unit is relocated to new logical addresses in the storage-unit.

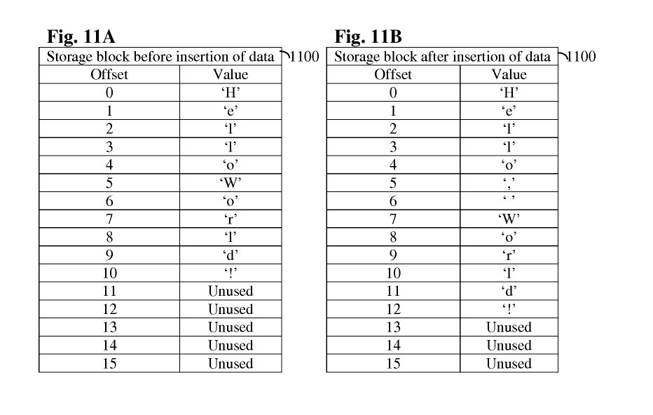

FIGS. 11A and 11B are schematic diagrams illustrating a logical representation of storage block 1100 and a logical representation of the storage block 1100 after insertion of data elements respectively, in accordance with an embodiment of the disclosed subject matter.

Referring to FIG. 11A, a storage block 1100 has a storage capacity of about 16 bytes. Storage block 1100 stores about 11 bytes, thereby providing a spare capacity of about 5 bytes. The spare capacity can be utilized for inserting more data elements.

Referring now to FIG. 11B, the spare capacity in storage block 1100, as shown in FIG. 11A, is utilized by inserting new data elements. After the insertion of new data elements, storage block 1100 (of FIG. 11B) still has a spare capacity of about 3 bytes. Thus, an additional 3 bytes of data may be inserted in a similar manner. In case data elements in excess of 3 bytes are to be added to storage block 1100 (of FIG. 11B), a new storage block is added as explained in conjunction with FIGS. 4A-4D.

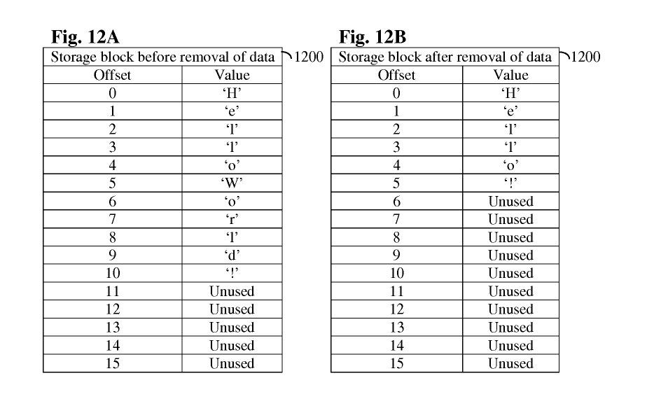

FIGS. 12A and 12B are schematic diagrams illustrating a logical representation of a storage block 1200 and a logical representation of the storage block 1200 after removal of data elements respectively, in accordance with an embodiment of the disclosed subject matter.

Referring to FIG. 12A, a storage block 1200 has a storage capacity of 16 bytes. Storage block 1200 stores 11 bytes, thereby, providing a spare capacity of about 5 bytes. Referring now to FIG. 12B, some data elements of storage block 1200 (of FIG. 12A) are removed. A total of 5 bytes of data are removed from the offset locations 5 to 9 of storage block 1200. Data stored at offset location 10 is shifted to a new position 5, thereby replacing the data that was present at position 5, and the remaining storage capacity in storage block 1200 from byte 6 to byte 15 becomes the spare capacity of storage block 1200. It is marked as unused in FIG. 12B.

In case all data elements are removed from storage block 1200 such that the effective size of storage block 1200 becomes null, storage block 1200 is removed from a sequence of storage blocks in a storage unit with which storage block 1200 was associated, as explained in conjunction with FIGS. 6A-6D.

In accordance with an embodiment of the disclosed subject matter, the spare capacity in the storage blocks in a storage unit, including spare capacity present in non-terminal storage blocks, is from time to time used, to store data relating to the same or another storage unit.

FIG. 13 shows a metafile 1300 in accordance with another embodiment of the disclosed subject matter. The metafile 1300 includes a logical address space 1302, having a number of logical addresses. The metafile 1600 includes a number of storage-blocks 1304. A storage-block 1304 may itself be a storage unit.

For instance,
a. A number of files and file-fragments are used as storage blocks in a metafile.
b. A number of memory regions are used to make a large memory region metafile.
c. A number of memory regions and a number of files are used as pages to make a large virtual memory metafile. The pages are mapped to the virtual address space using a page table in a memory-management-unit.
d. A number of memory regions and a number of data structures are used as storage blocks in a metafile.

Thus, each storage-block has its own logical address space. Each storage-block 1304 thus has variable-capacity.

Logical address space 1302 in the metafile is the accumulation of the logical address spaces of the storage-blocks. For example, if a first, a second, and a third storage-block in the metafile have 2300, 2555, and 7453 logical addresses respectively, the number of logical addresses in the metafile is 12308. The first storage block is mapped at logical addresses 0 to 2299 in the metafile. The second storage-block is mapped at logical addresses 2300 to 4854, and so on.

Metafile 1300 provides the ability to store, retrieve, insert, and remove data elements in the metafile, in accordance with the various embodiments of the disclosed embodiments.

Data is inserted in the metafile by inserting one or more data elements in a storage-block. Data is also inserted in the metafile by inserting one or more additional storage-blocks in the metafile.

When a large number of data elements are inserted into a storage-block, the efficiency of the metafile may be reduced. In order to maintain efficiency of operation, the metafile limits the number of data elements that may be stored in a storage-block. The limit may vary from storage-block to storage-block. When the size of a storage-block exceeds the limit, a new storage-block is inserted and the data is re-distributed among the storage-blocks Similarly, the data in two or more storage-blocks may be merged if the amount of data in the storage-blocks is less than another predetermined limit. Similarly, data may be removed from the metafile.

An advantage of the metafile is that it allows the user to overcome some disadvantages of a storage-block, while providing the ability to insert and remove data efficiently. In an embodiment of the disclosed subject matter, some or all files used as storage-blocks in a metafile may be read-only. During insertion of data, if the logical address of the point of insertion maps to a read-only storage-block, the storage block is logically split into two read-only storage-blocks having the first part of the storage-block, and the remaining part of the storage-block. A new storage-block, storing the inserted data, is then inserted between these two storage-blocks. This is achieved without requiring that the original contents of the read-only storage unit are modified.

Another advantage of the metafile is that the data in a storage-block may be directly accessed using the logical address space of the storage-block. When data in a storage-block is directly modified, inserted, or removed, the data in the metafile at the corresponding logical addresses is also modified, inserted, or removed.

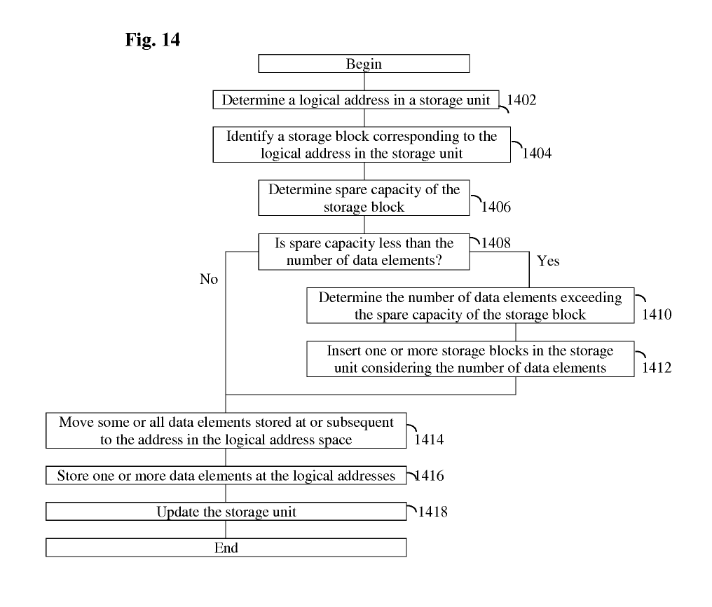

FIG. 14 depicts a flowchart illustrating a method for inserting data elements in a storage unit, in accordance with an embodiment of the disclosed subject matter.

The process begins at step 1402, when one or more data elements are to be inserted within an existing series of data elements into a storage unit, a logical address corresponding to the point of insertion is determined.

At step 1404, a storage block corresponding to the logical address in the storage unit is identified. The one or more storage blocks in the storage unit have variable effective size. The storage block in which the data elements are to be inserted is identified based on the logical address corresponding to the point of insertion and the effective size of the one or more storage blocks.

At step 1406, the spare capacity of the identified storage block is determined At step 1408, the spare capacity of the storage block is compared with the number of data elements to be inserted. In case the spare capacity is less than the number of data elements to be inserted, then, at step 1410, the number of data elements exceeding the spare capacity of the storage block is determined. Subsequently, at step 1412, one or more storage blocks are inserted into the storage unit based on the number of data elements in excess of the spare capacity of the identified storage block.

At step 1414, some or all data elements that are stored at or subsequent to the logical address are moved to new logical addresses in the storage unit. At step 1416, the inserted data elements and the moved data elements are stored at respective logical addresses in the storage unit. Finally, at step 1418, the sequence of storage blocks is updated in accordance with the insertion of the one or more storage blocks.

In accordance with an embodiment of the disclosed subject matter, one or more additional data elements may be inserted into a storage unit at a predetermined logical address by moving data elements at or beyond the logical address to higher logical addresses by re-mapping the data elements or storage blocks. According to an embodiment of the disclosed subject matter, the insertion of data elements is performed by mapping more logical addresses to data elements in one or more storage blocks, i.e. increasing the effective size of the storage blocks. An alternate method is addition of one or more additional storage blocks in the device, and mapping the storage blocks and the data therein to appropriate logical addresses. In another alternate method, the data elements are inserted by replacement of one or more existing storage blocks in the device with a set of new storage blocks, and mapping one or more logical addresses to data elements in the new storage blocks.

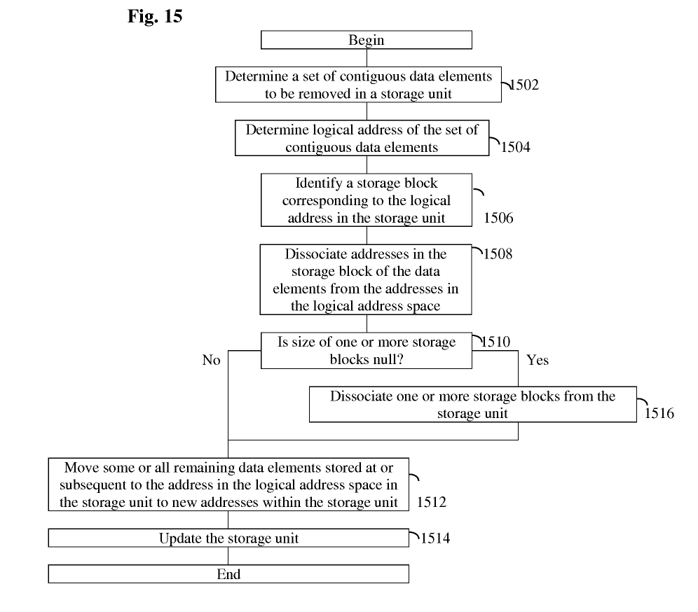

FIG. 15 depicts a flowchart illustrating a method for removing data elements from a storage unit, in accordance with an embodiment of the disclosed subject matter.

At step 1502, a set of contiguous data elements to be removed from a storage unit is determined. Thereafter, at step 1504, a logical address corresponding to the set of contiguous data elements in the storage unit is determined

At step 1506, a storage block corresponding to the logical address in the storage unit is identified. The one or more storage blocks in the storage unit have variable effective size. The storage block from which the data elements are to be removed is identified based on the logical address corresponding to the set of contiguous data elements and the effective size of the one or more storage blocks.

At step 1508, the addresses in the storage blocks of a set of contiguous data elements are dissociated from the logical address space. Subsequently, at step 1510, the effective size of one or more storage blocks is determined. If at step 1510, the used storage capacity of the storage block is null, then at step 1516, the one or more storage blocks are dissociated from the storage unit. Further, at step 1512, some or all remaining data elements stored at or subsequent to the logical address in the storage unit are moved to new logical addresses within the storage unit. Finally, at step 1514, the sequence of storage blocks is updated in accordance with the dissociation or removal of the one or more storage blocks.

In accordance with an embodiment of the disclosed subject matter, one or more existing data elements at a predetermined logical address may be removed from a storage unit by dissociating one or more logical addresses which were previously associated with data elements in one or more storage blocks, i.e. decreasing the effective size of the one or more storage blocks, followed by re-arrangement of data elements in the storage block.

According to an embodiment of the disclosed subject matter, one or more existing data elements at a predetermined logical address may be removed from a storage unit by un-mapping one or more existing storage blocks, and the data therein, from the logical address space, and removing such existing storage blocks from the storage unit. An alternate method may include moving one or more data elements at or beyond the logical address to lower logical addresses by remapping the data elements in the storage blocks. In another alternate method, data elements may be removed by replacing one or more existing storage blocks in the device with a set of new storage blocks, and/or mapping one or more logical addresses to data elements in such new storage blocks.

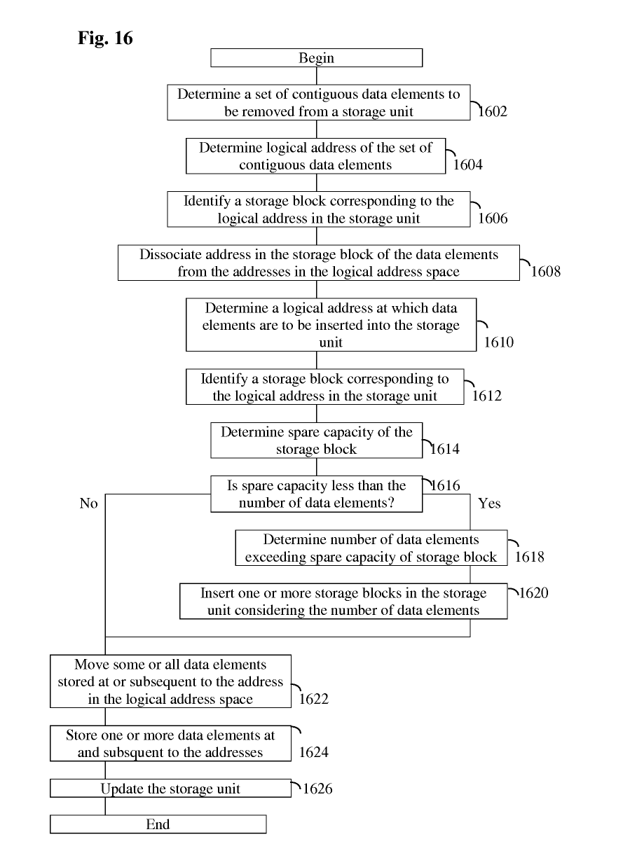

FIG. 16 depicts a flowchart illustrating a method for replacing a storage block in a storage unit, in accordance with an embodiment of the disclosed subject matter.

At step 1602, a set of contiguous data elements to be removed from a storage unit is determined. Thereafter, at step 1604, a logical address, corresponding to the set of contiguous data elements, in the storage unit is determined

At step 1606, a storage block corresponding to the logical address in the storage unit is identified. The one or more storage blocks in the storage unit have variable effective sizes. The storage block from which the data elements are to be removed is identified based on the logical address corresponding to the set of contiguous data elements and the effective size of the one or more storage blocks.

At step 1608, the addresses in the storage blocks of a set of contiguous data elements are dissociated from the logical address space in the storage unit. Subsequently, at step 1610, when one or more data elements are to be inserted into a storage unit, a logical address corresponding to the point of insertion is determined.

At step 1612, a storage block corresponding to the logical address in the storage unit is identified. The one or more storage blocks in the storage unit have variable effective size. The storage block in which the data elements are to be inserted is identified based on the logical address corresponding to the point of insertion and the effective size of the one or more storage blocks.

At step 1614, the spare capacity of the identified storage block is determined At step 1616, the spare capacity of the storage block is compared with the number of data elements to be inserted. In case the spare capacity is less than the number of data elements to be inserted, then, at step 1618, the number of data elements exceeding the spare capacity of the storage block is determined. Subsequently, at step 1620, one or more storage blocks are inserted into the storage unit based on the number of data elements in excess of the spare capacity of the identified storage block.

Replacement of a storage block is a combination of removal of a storage block from an appropriate position and insertion of another storage block at the position. Data may be inserted or removed from the storage unit by replacing an existing storage block with another storage block with larger or smaller capacity, or with larger or smaller effective size of the storage block.

In accordance with an embodiment of the disclosed subject matter, re-arrangement of storage blocks in the storage unit includes the removal of one or more storage blocks from a position in the sequence of storage blocks in the storage unit, and insertion of such storage blocks at another position in the sequence in the storage unit. By re-arranging storage blocks in the storage unit, data is removed from one position and inserted into another position within the storage block. This also causes the data elements in some storage blocks in the storage unit to be moved to higher or lower logical addresses, without accessing or copying data in such storage blocks.

At step 1622, some or all data elements that are stored at or subsequent to the logical address are moved to a new logical address in the storage unit. At step 1624, the inserted data elements and the moved data elements are stored at respective logical addresses in the storage unit. Finally, at step 1626, the sequence of storage blocks is updated in accordance with the insertion of the one or more storage blocks.

Therefore, data storage device of the disclosed subject matter provides an efficient management of data, thereby improving efficiency of data storage device, data processing device, and operating system associated with the data storage device. The data storage device provides efficient methods for insertion of data in a storage block, removal of data from a storage block, replacement of data in a storage block, insertion of storage block in a storage unit, removal of storage block in a storage unit, replacement of storage block in a storage unit, rearrangement of storage blocks in a storage unit.

Further, the device provides methods for fast addition or insertion, and removal of data in a storage block, storage unit, and an array of data. The fast insertion or removal of data further provides an advantage of avoiding sorting an array of data elements in a data structure, as modification of data is performed at appropriate positions in the sorted array.

Most importantly, when one or more bytes are to be inserted into the sequence, a storage unit is not required to be entirely loaded. The data is inserted at an appropriate position within storage unit. The sequence described herein, is applicable to, but is not limited to, any data structure, any array of data, and any data processing application. Examples include, but are not limited to, insertion of a character, word, or phrase in a text-editor application, insertion of new entries in a sorted array in a file storage unit, insertion of new elements in an array of elements.

The disclosed subject matter is applicable to data storage devices used in database systems, operating systems, computing devices, computer networks, communication networks, network servers, data processing devices and the like. The applications include, but are not limited to, academic databases, databases of organizations, government databases, computing devices like computers, mobile phones, network-attached storage devices, data recovery systems, electronic consumer devices, electronic industrial devices, and the like.

Further, the data storage system is capable of inserting data at appropriate positions and removing data from appropriate positions in a storage unit, without modifying data beyond the point of insertion or removal. The data storage device facilitates efficient utilization of processing time of the data processing device. The data storage device eliminates a necessity for sorting data in a sorted array, when a modification of data occurs in the array. Further, the disclosed subject matter reduces data size, and makes it easier to manipulate, store, and transmit data. Further, the disclosed subject matter makes application programs easier, simpler, smaller, faster and more reliable.

While the preferred embodiments of the disclosed subject matter have been illustrated and described, it will be clear that the disclosed subject matter is not limited to these embodiments only. Numerous modifications, changes, variations, substitutions and equivalents will be apparent to those skilled in the art without departing from the spirit and scope of the disclosed subject matter as described in the claims.

1. A method for inserting, or relocating one or more data elements at a predetermined logical address in a series of data-elements stored in a storage unit, the storage unit configured to simultaneously update, insert or remove two or more data elements, by inserting one or more additional storage addresses in an existing range of storage addresses in the storage unit.

2. The method of claim 1, wherein the one or more additional storage addresses are inserted in the existing range of storage addresses by using spare capacity in one or more storage blocks in the storage unit.

3. The method of claim 1, wherein the storage unit is at least one of:
a. a file;
b. a data structure;
c. a metafile;
d. a memory mapped file;
e. a memory region in a virtual memory system including a number of equal-sized pages mapped to the logical address space; and
f. a memory region in a virtual memory system including a number of variable-sized pages mapped to the logical address space.

4. A method for inserting, removing, or relocating one or more data elements at a predetermined logical address in a series of data-elements stored in a storage unit, the storage unit configured to simultaneously insert or remove two or more data elements, the method comprising at least two of:
a. inserting one or more storage addresses in an existing range of storage addresses in the storage unit;
b. inserting or removing one or more ranges of storage addresses in the storage unit; and
c. dissociating one or more ranges of storage addresses from logical addresses and re-associating said one or more ranges of storage addresses with new logical addresses, without updating data mapping entries corresponding to said one or more ranges of storage addresses.

5. The method of claim 4, configured to perform at least one of:
a. split data in a range of storage addresses into two or more ranges of storage addresses;
b. merge data from two or more ranges of storage addresses into a range of storage addresses; and
c. copy one or more data elements from a range of storage addresses to another range of storage addresses in the storage-unit.

6. The method of claim 4, wherein one or more storage addresses are associated with logical addresses in a second logical address space.

7. The method of claim 4, wherein the storage unit is at least one of:
a. a file;
b. a data structure;
c. a metafile;
d. a memory mapped file;
e. a memory region in a virtual memory system including a number of equal-sized pages mapped to the logical address space; and
f. a memory region in a virtual memory system including a number of variable-sized pages mapped to the logical address space.

8. A device for insertion, or relocation of one or more data elements at a predetermined logical address in a series of data-elements stored in a storage unit, comprising
a. a storage unit configured to simultaneously update, insert, or remove two or more data elements, the storage unit including
i. a logical address space having a number of logical addresses;
ii. a number of storage blocks having a number of ranges of storage addresses, each range having one or more storage addresses; and
iii. a data mapping module, the data mapping module including a number of data mapping entries for associating one or more ranges of storage addresses with logical addresses;
b. an address remapping module for modifying the association of one or more ranges of storage addresses with logical addresses; and
c. a data reconfiguration module configured to insert one or more storage addresses in an existing range of storage addresses.

9. The device of claim 8, wherein the one or more additional storage addresses are inserted in the existing range of storage addresses by using spare capacity in one or more storage blocks in the storage unit.

10. The method of claim 8, wherein the storage unit is at least one of:
a. a file;
b. a data structure;
c. a metafile;
d. a memory mapped file;
e. a memory region in a virtual memory system including a number of equal-sized pages mapped to the logical address space; and
f. a memory region in a virtual memory system including a number of variable-sized pages mapped to the logical address space.

11. A device for insertion, or relocation of one or more data elements at a predetermined logical address in a series of data-elements stored in a storage unit, comprising
a. a storage unit configured to simultaneously update, insert, or remove two or more data elements, the storage unit including
i. a logical address space having a number of logical addresses;
ii. a number of storage blocks having a number of ranges of storage addresses, each range having one or more storage addresses; and
iii. a data mapping module, the data mapping module including a number of data mapping entries for associating one or more ranges of storage addresses with logical addresses;
b. an address remapping module for modifying the association of one or more ranges of storage addresses with logical addresses; and
c. a data reconfiguration module configured to perform at least two of:
i. insert one or more storage addresses in an existing range of storage addresses;
ii. insert or remove one or more ranges of storage addresses in the storage unit; and
iii. dissociate one or more ranges of storage addresses from logical addresses and re-associate said one or more ranges of storage addresses with new logical addresses, without updating data mapping entries corresponding to said one or more ranges of storage addresses.

12. The device of claim 11, wherein the data reconfiguration module is further configured to perform at least one of:
a. split data in a range of storage addresses into two or more ranges of storage addresses;
b. merge data from two or more ranges of storage addresses into a range of storage addresses; and
c. copy one or more data elements from a range of storage addresses to another range of storage addresses in the storage-unit.

13. The device of claim 11, wherein one or more storage addresses are associated with logical addresses in a second logical address space.

14. The device of claim 11, wherein the storage unit is at least one of:
a. a file;
b. a data structure;
c. a metafile;
d. a memory mapped file;
e. a memory region in a virtual memory system including a number of equal-sized pages mapped to the logical address space; and
f. a memory region in a virtual memory system including a number of variable-sized pages mapped to the logical address space.
